(19) United States
(12) Patent Application Publication
(10) Pub. No.: US 2014/0095248 A1
(43) Pub. Date: Apr. 3, 2014

(54) SUPPLY CHAIN FINANCIAL ORCHESTRATION SYSTEM WITH TASK COMMUNICATION USING UNIVERSAL FORMAT

(71) Applicant: Oracle International Corporation, Redwood Shores, CA (US)

(72) Inventors: Balaji DUVARAGAMANI, Hyderabad (IN); Kalyana Chakravarthy DANDE, Hyderabad (IN); Raveesh YADAV, Hyderabad (IN); Girish JHA, Hyderabad (IN); Kalyani MANDA, Hyderabad (IN)

(73) Assignee: Oracle International Corporation, Redwood Shores, CA (US)

(21) Appl. No.: 14/040,627

(22) Filed: Sep. 28, 2013

Related U.S. Application Data
(60) Provisional application No. 61/707,630, filed on Sep. 28, 2012.

(51) Int. Cl. G06Q 10/06

(52) U.S. Cl. CPC G06Q 10/06315
USPC 705/7.25

(57) ABSTRACT

A system is provided that communicates tasks. The system generates a task including task payload data, where the task payload data is in a task payload format. The system further transforms the task payload data from the task payload format to a universal format. The system further sends the task payload data and a system parameter to an external interface layer, where the task payload data is sent in the universal format, and where the system parameter identifies an external target system. The system further identifies an external target system and connector service based on the system parameter. The system further sends the task payload data to the connector service, where the task payload data is sent in the universal format.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

Large multi-national companies, or other enterprises, often operate through a number of subsidiary companies, or other legal entities, spread across the globe. These subsidiary companies can be further divided into business units or lines of businesses. The intersection of each subsidiary company and line of business (identified as a “profit center business unit”) can become a supply chain entity that engages in manufacturing, purchase, and/or sale of goods and services.

The profit center business units typically engage commercially with an external supply chain, such as a collection of suppliers and customers. They can also engage in internal trades, or internal transfers, within the subsidiary company. One example type of an internal trade is an “inter-company trade,” where a profit center business unit belonging to one subsidiary company trades with a profit center business unit belonging to another subsidiary company, at arm's length terms and conditions. Another example type of an internal trade is an “intra-company trade,” where two profit center business units belonging to the same subsidiary company trade among each other on a competitive basis. Such internal trades can trigger internal transactions pre-defined as part of internal trade relationship. Further, such internal trades can trigger one or more tasks to be executed. Such tasks may require that messages be sent to target external systems, in order for the tasks to be executed at the target external systems. Such target external systems can each have different task payload formats.

### SUMMARY

One embodiment is a system that communicates tasks. The system generates a task including task payload data, where the task payload data is in a task payload format. The system further transforms the task payload data from the task payload format to a universal format. The system further sends the task payload data and a system parameter to an external interface layer, where the task payload data is sent in the universal format, and where the system parameter identifies an external target system. The system further identifies an external target system and connector service based on the system parameter. The system further sends the task payload data to the connector service, where the task payload data is sent in the universal format.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example supply chain financial orchestration flow, according to an embodiment of the invention.

FIG. 3 illustrates a block diagram of an example architecture of a supply chain financial orchestration system, according to an embodiment of the invention.

FIG. 4 illustrates a block diagram of a task communication pattern for a system.

FIG. 5 illustrates a block diagram of an input payload of an external interface layer.

FIG. 6 illustrates a block diagram of a task communication pattern after payload modification to the task layer services of a system.

FIG. 7 illustrates a block diagram of a task communication pattern that includes a universal format, according to an embodiment of the invention.

FIG. 8 illustrates a block diagram of a connector service that transforms a universal format to an external target system format, according to an embodiment of the invention.

FIG. 9 illustrates a flow diagram of the functionality of a supply chain financial orchestration task communication module, according to an embodiment of the invention.

### DETAILED DESCRIPTION

According to an embodiment, a supply chain financial orchestration system is provided that can communicate different types of payload data for different supply chain tasks (such as purchase order tasks, sales order tasks, payable tasks, or receivable tasks) with different external target systems using a universal format, where the different types of task payload data can have different formats, and where the different external target systems can also have different formats. The supply chain financial orchestration system can further handle modifications to the task payload data (such as modifications to a task payload data structure or the integration of new tasks) without requiring modifications to the universal format. As understood by one of ordinary skill in the art, payload data is data contained within a data communication, where an example of a data communication is a message.

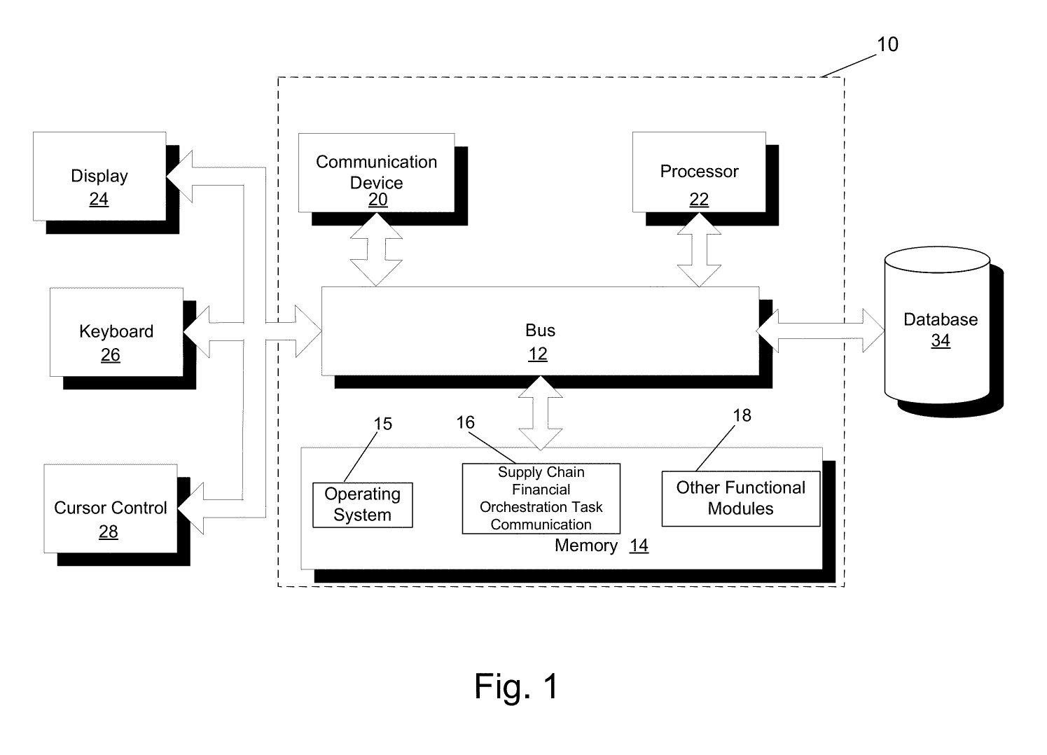

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial orchestration task communication module 16, as well as other functional modules 18. Operating system 15 can provide an operating system functionality for supply chain financial orchestration system 10. Supply chain financial orchestration task communication module 16 can provide functionality for communicating tasks, as is described in more detail below. In certain embodiments, supply chain financial orchestration task communication module 16 can comprise a plurality of modules that each provide specific individual functionality for communicating tasks. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as an “Oracle Fusion Applications” product from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

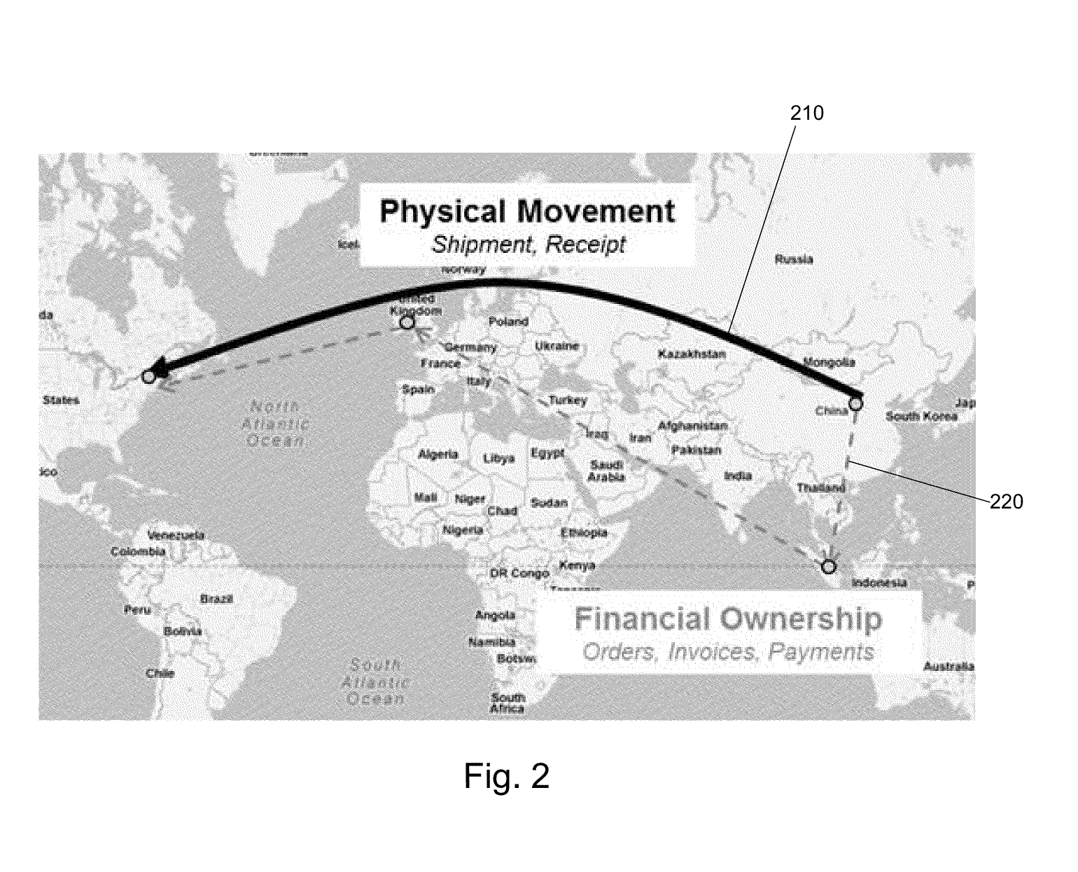

FIG. 2 illustrates an example supply chain financial orchestration flow, according to an embodiment of the invention. The supply chain financial orchestration flow is between a shipping entity in China and a receiving entity in the United States. As illustrated in FIG. 2, the supply chain financial orchestration flow includes a physical movement flow 210 and a financial flow 220. Physical movement flow 210 represents the physical movement of items from the shipping entity in China, to the receiving entity in the United States, and can involve the physical movement through one or more intermediate entities. Physical movement flow 210 can include one or more physical transactions that are executed in association with the physical movement of the items (such as shipments, receipts, etc.). Financial flow 220 represents the change in financial ownership of items from the shipping entity in China, to the receiving entity in the United States, and can involve the change in financial ownership of one or more intermediate entities. Financial flow 220 can include one or more financial transactions that are executed in associate with the change in financial ownership of the items (such as orders, invoices, payments, etc.). As illustrated in FIG. 2, a physical movement flow can be separate and independent of a financial flow within a supply chain financial orchestration system.

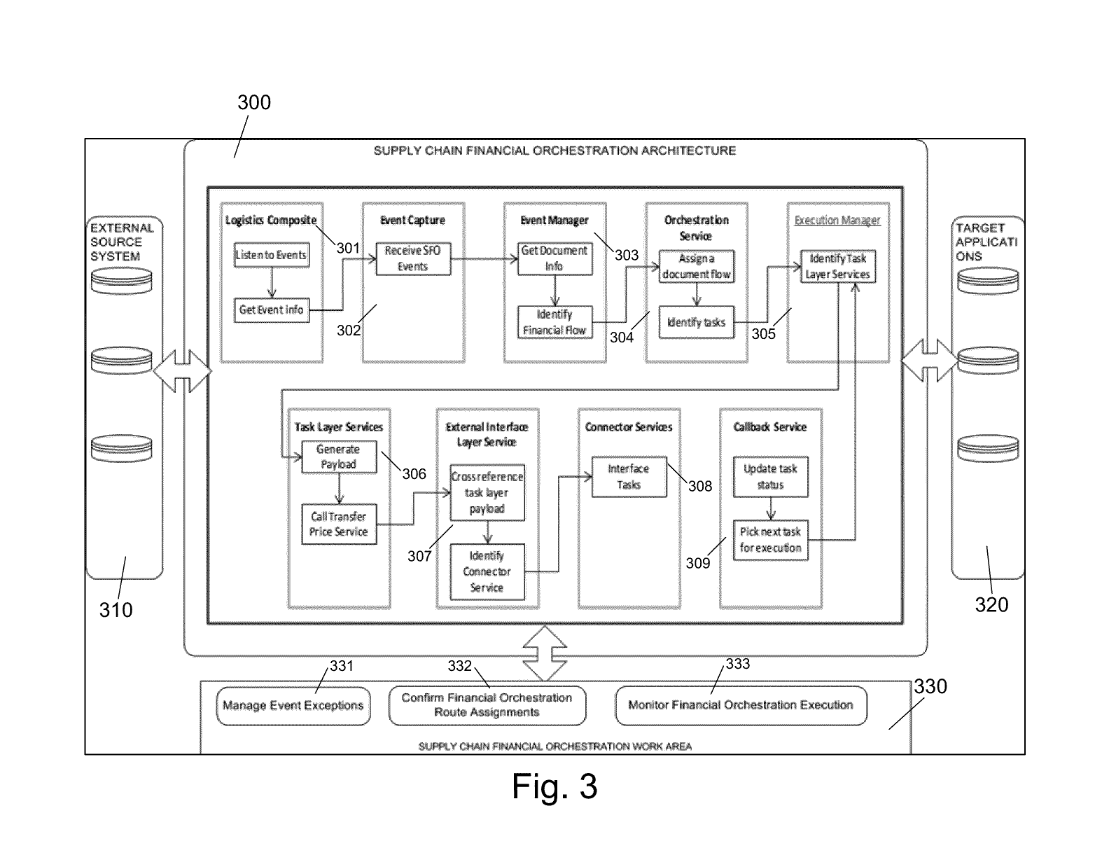

FIG. 3 illustrates a block diagram of an example architecture of a supply chain financial orchestration system 300, according to an embodiment of the invention. According to the embodiment, supply chain financial orchestration system 300 is a configurable system that manages internal trade relationships between entities belonging to an enterprise, where the enterprise is typically spread across geographies. Supply chain financial orchestration system 300 can define a nature of trade relationships, business rules, internal controls, regulatory compliances, and other terms and conditions required to execute, monitor, and evaluate trade transactions emanating out of such relationships. More specifically, supply chain financial orchestration system 300 can listen to events that occur in supply chain transactions in various external source systems, and can identify internal transactions (such as inter-company transactions and intra-company transactions) based on pre-defined trade relationships. Once the internal transactions are identified, supply chain financial orchestration system 300 can create necessary accounting and documentations required to be generated for the internal transactions according to the business rules defined in supply chain financial orchestration system 300.

According to the illustrated embodiment, supply chain financial orchestration system 300 includes event mediator 301, event capture 302, event manager 303, orchestration service 304, execution manager 305, task layer service 306, external interface layer service 307, connector service 308, and callback service 309. Event mediator 301 listens for events generated by an external source system (i.e., application) of external source systems (i.e., applications) 310. If an event is of interest to supply chain financial orchestration system 300, event mediator 301 can also call a web service exposed by the external source system of external source systems 310 to enrich the event details. Event mediator 301 then sends the event to event capture 302. Event capture 302 validates the event details retrieved after enrichment, and stores the event in an external source system format.

Subsequently, event manager 303 identifies a source document enrichment web service based on a source order type, and calls the source document enrichment web service for enrichment. The source document enrichment service is exposed by an external source system of external source systems 310 where the source order originated. Event manager 303 can pass a source document identifier as an input parameter to the enrichment web service and can retrieve the source document information, where a source document identifier is a unique identifier of the source document that is communicated to the external source system of external source systems 310. The external source system of external source systems 310 that is responsible for capturing the physical transaction can be responsible for passing the source document identifier as part of event information. Supply chain financial orchestration system 300 can maintain an association between a supply chain event and a source document type. Event manager 303 can further transform the source document information into a format that is understandable by supply chain financial orchestration system 300, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 304 verifies whether a supply chain financial orchestration flow is already assigned to a source document or not. If the supply chain financial orchestration flow is not already assigned, orchestration service 304 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks that are to be performed can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 304 can generate the tasks for creating trade distributions to book supplier accrual and costs in a costing system, as well. Execution manager 305 invokes a task layer service based on a task type. Generally, the tasks are performed in a defined sequence, and if there is any dependency from a previous task, execution manager 305 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 306 creates a task layer service payload. Task layer service 306 can include logic to populate the payload data depending on a global procurement flow, a customer shipment flow, or an internal transfer flow. Task layer service 306 can also call a transfer price service to get a transfer price, where the transfer price is a price in which a selling entity sells goods to a purchasing entity, where the selling entity and the purchasing entity are involved in an internal trade. External interface layer service 307 identifies a target system (i.e., application) of target systems (i.e., applications) 320, and obtains a connector service (e.g., connector service 308) for the target system of target systems 320 based on the task type. Connector service 308 transforms the task layer service payload into a format which is understandable by the target system of target systems 320. Once the task data is transformed according to a target system format, connector service 308 calls a web service to interface tasks in interface tables of the target system of target systems 320. Callback service 309 receives responses from the target system of target systems 320 and updates the task status. If the task is a last task in a sequence, then the supply chain financial orchestration is complete. Otherwise, the next task in the sequence is selected, and execution manager 305 is invoked with the task type.

Supply chain financial orchestration system 300 further includes a supply chain financial orchestration work area 330 that includes a plurality of user interfaces that allow a user to interact with supply chain financial orchestration system 300. Supply chain financial orchestration work area 330 includes manage event exceptions 331, confirm financial orchestration route assignments 332, and monitor financial orchestration execution 333. Manage event exceptions 331 is a user interface that allows users to view, troubleshoot, and manage events which faulted due to a setup or technical reason. Confirm financial orchestration route assignments 332 is a user interface that allows a user to confirm a supply chain financial orchestration flow before the tasks of the supply chain financial orchestration flow are initiated by orchestration service 304. Monitor financial orchestration execution 333 is a user interface that allows user to monitor supply chain financial orchestration flows that are in progress, that have not started, and that have completed.

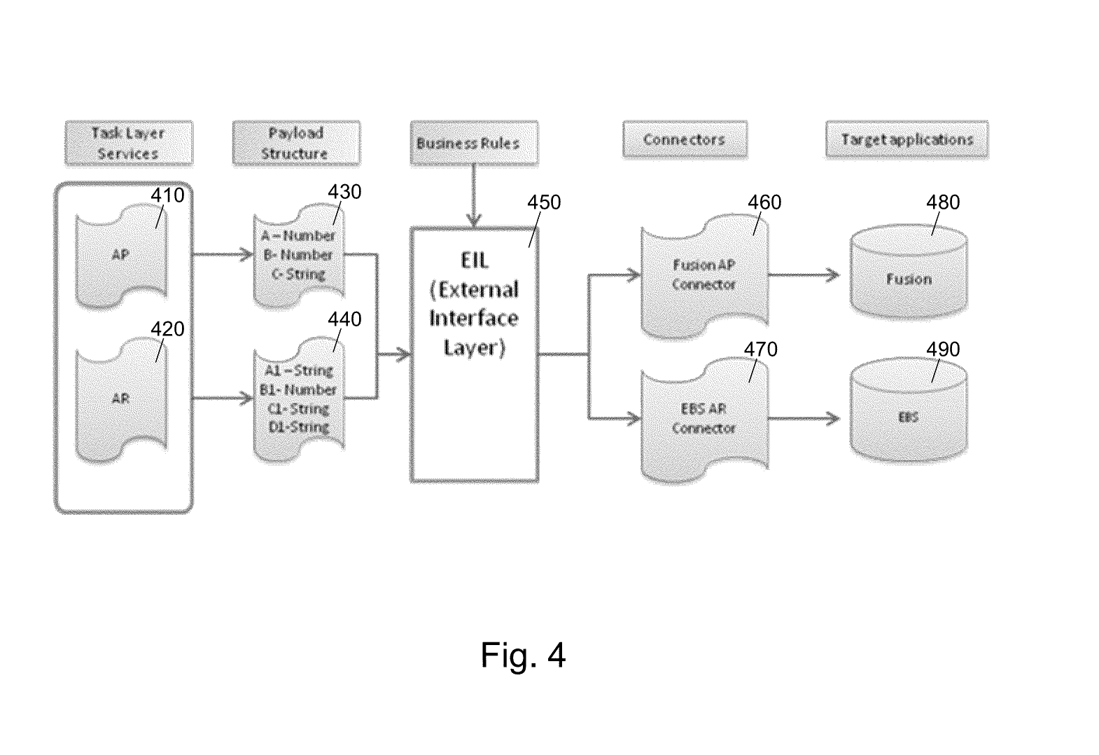

FIG. 4 illustrates a block diagram of a task communication pattern for a system, such as a supply chain financial orchestration system. As previously described, upon on occurrence of an event, a supply chain financial orchestration system can generate tasks that are to be performed between internal entities based on a supply chain financial orchestration flow. As also previously described, the supply chain financial orchestration system can identify an external target system, and obtain a connector service based on the task type. The supply chain financial orchestration system can then send the task to the external target system using the connector service, where the task is executed at the external target system.

In one example, two tasks, an accounts payable (“AP”) task and an accounts receivable (“AR”) task are interfaced to an appropriate external target system. A task payload format of the AP task can be as follows:

| Parameter | Data Type |
|---|---|
| A | Number |
| B | Number |
| C | String |

Further, a task payload format of the AR task can be as follows:

| Parameter | Data Type |
|---|---|
| A1 | String |
| B1 | Number |
| C1 | String |
| D1 | String |

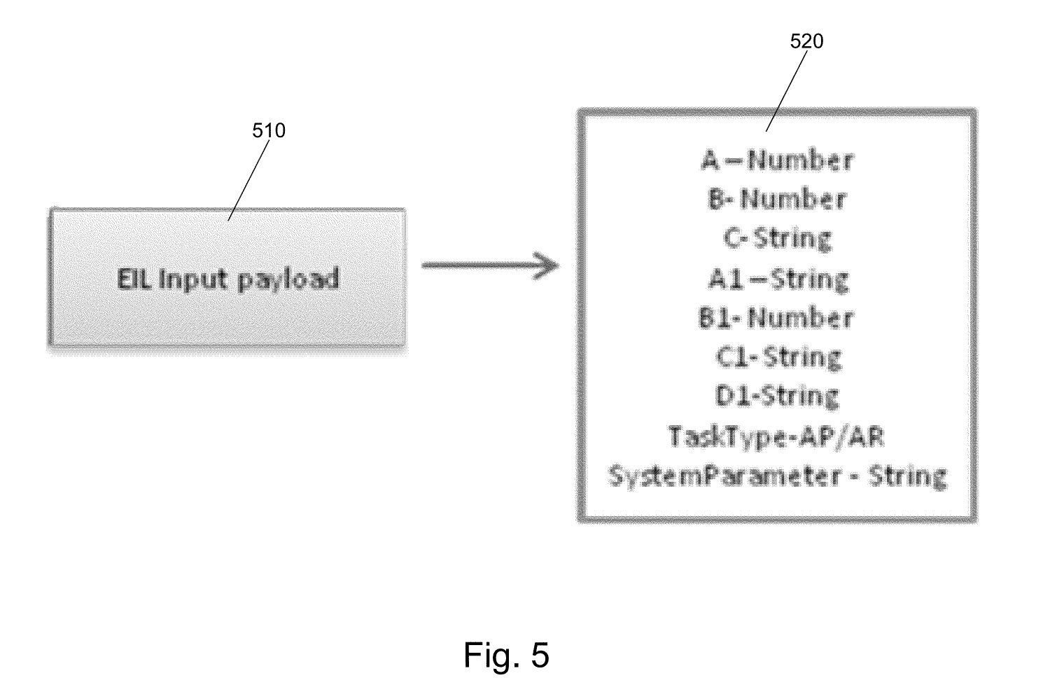

As illustrated in FIG. 4, AP task layer service 410 and AR task layer service 420 prepare task payload data for an AP task and an AR task, respectively. A task payload format (or “structure”) of AP task layer service 410 is illustrated as AP task payload format 430, and a task payload format (or “structure”) of AR task layer service 420 is illustrated as AR task payload format 440. AP task layer service 410 and AR task layer service 420 each send their respective task payload data to an external interface layer (“EIL”) 450, which stores each task payload data (i.e., the task payload data of AP task layer service 410 and the task payload data of AR task layer service 420) in an EIL format. The EIL format of EIL 450 is further described below in greater detail in conjunction with FIG. 5. EIL 450 further sends the task payload data of AP task layer service 410 to AP connector service (or “connector”) 460, and further sends the task payload data of AR task layer service 420 to AR connector service (or “connector”) 470. AP connector 460 then performs a transformation of the task payload data of AP task layer service 410 to a format of external target system 480, and sends the transformed task payload data to external target system 480. Similarly, AR connector 470 performs a transformation of the task payload data of AR task layer service 420 to a format of external target system 490, and sends the transformed task payload data to external target system 490.

FIG. 5 illustrates a block diagram of an input payload of an external interface layer. More specifically, FIG. 5 illustrates an EIL input payload 510, which represents payload data that is stored within an EIL. Further, FIG. 5 illustrates an EIL input payload format 520. Input payload format 520 is a union of AP task payload format 430 and AR task payload format 440 of FIG. 4. EIL input payload format 520 also includes a task type parameter that identifies whether the payload data is associated with an AP task or an AR task. Further, EIL input payload format 420 also includes a system parameter that identifies an external target system that the payload data is associated with (and is to be sent to).

As illustrated in FIG. 4, an EIL (such as EIL 450) is located between a payload generating application (such as a task layer service) and a connector service for an external target system. The primary job of an EIL is to identify an appropriate connector service to which the payload data is to be sent. The identified connector service further identifies an appropriate external target system. A task layer service generates a task payload data, and sends the task payload data to the EIL, along with a system parameter, for further processing.

The EIL can refer to a setup table which contains a mapping between a target uniform resource locator (“URL”) and one or more system parameters. The EIL, based on the input system parameters, can identify an external target system and target URL from the setup table. An example setup table is shown below:

| Task Type | System Parameter | Target URL | Target System |
|---|---|---|---|
| AP | S1 | http://Fusion/AP | Fusion |
| AR | S2 | http://Ebs/AR | Ebs |

Once an external target system is identified, the payload data can be routed to an appropriate connector service after transformation. The EIL can remain immune to business data and can focus on routing the payload data to a specific connector service. Any transformation of the payload data can be implemented by the appropriate connector service which interfaces with the external target system.

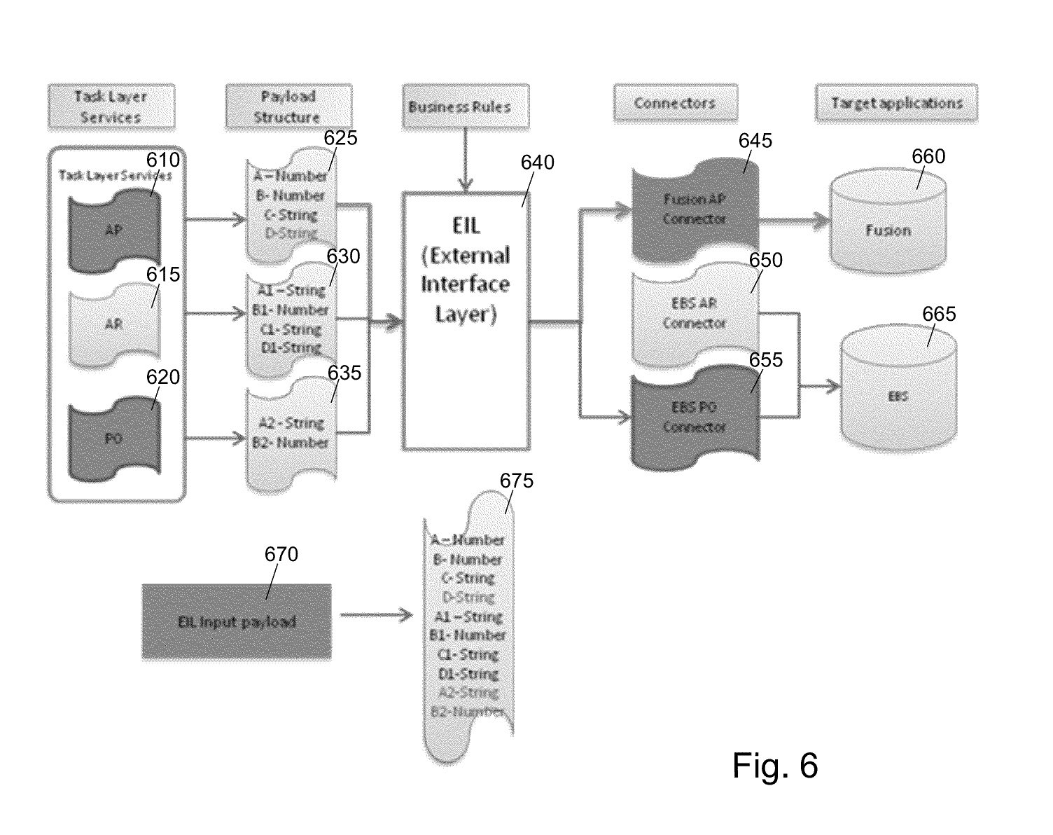

Since the EIL integrates with different task layer services, any payload modifications to a task layer service can affect the EIL payload format and also the corresponding connector service. Consider the following sample scenario: (1) a new parameter ‘D’ of type “String” is introduced to an AP task layer service; and (2) a new task layer service (i.e., a purchase order (“PO”) task layer service) is added. As described below in conjunction with FIG. 6, such changes can require changes to specific task payload data formats, which require changes to an EIL payload format, and changes to corresponding connector service. Such modifications can also require redeployment of those components into the supply chain financial orchestration system.

FIG. 6 illustrates a block diagram of a task communication pattern after payload modification to the task layer services of a system, such as a supply chain financial orchestration system. More specifically, the block diagram illustrated in FIG. 6 includes AP task layer service 610, AR task layer service 615, and PO task layer service 620. The block diagram illustrated in FIG. 6 also includes AP task payload format 625 (which is a task payload format, or “structure,” of AP task layer service 610), AR task payload format 630 (which is a task payload format of AR task layer service 615), and PO task payload format 635 (which is a task payload format of PO task layer service 615).

AP task layer service 610 is different from AP task layer service 410 of FIG. 4, as AP task layer service 610 is modified to populate the new parameter ‘D’ of type “String.” Further, AP task payload format 625 is different from AP task payload format 430 of FIG. 4, as AP task payload format 625 is modified to include the new parameter ‘D’ of type “String.” AR task layer service 615 and AR task payload format 630 are identical to AR task layer service 420 and AR task payload format 440 of FIG. 4, respectively, as no parameters of AR task layer service 615 are modified. PO task layer service 620 is a new task layer service that is not present in the block diagram illustrated in FIG. 4. Similarly, PO task payload format 635 is a new task payload format that is not present in the block diagram illustrated in FIG. 4.

The block diagram in FIG. 6 further includes EIL 640. EIL 640 is different from EIL 450 of FIG. 4 because the modifications to AP task payload format 625, as well as the inclusion of new PO task payload format 635, are reflected in EIL 640. More specifically, an EIL input payload of EIL 640 is modified, as an EIL input payload format of EIL 640 is a union of AP task payload format 625, AR task payload format 630, and PO task payload format 635, and the union of these task payload formats includes new parameters (i.e., new parameter ‘D’ of AP task payload format 625, and new parameters ‘A2’ and ‘B2’ of task payload format 635). Thus, the block diagram of FIG. 6 includes EIL input payload 670 and EIL input payload format 675, where EIL input payload 670 is different from EIL input payload 510 of FIG. 5, and EIL input payload format 675 is different from EIL input payload format 520 of FIG. 5, as EIL input payload format 675 includes new parameter ‘D’ of AP task payload format 625, and new parameters ‘A2’ and ‘B2’ of task payload format 635. Further, a mapping from AP task layer service 610 to EIL 640 is modified to incorporate a mapping of the new parameter ‘D’ of type “String.”

The block diagram in FIG. 6 further includes AP connector service 645, AR connector service 650, and PO connector service 655. AP connector service 645 is different from AP connector service 460 of FIG. 4, as AP connector service 645 is modified to map the new parameter ‘D’ of type “String” to an external target system. Further, a mapping from EIL 640 to AP connector service 645 is modified to incorporate a mapping of the new parameter ‘D’ of type “String” from EIL 640 to AP connector service 645. AR connector service 650 is identical to AR connector service 470 of FIG. 4, as no parameters of AR connector service 650 are modified. PO connector service 655 is a new connector service, and is not present in FIG. 4

The block diagram illustrated in FIG. 6 also includes external target systems 660 and 665. External target systems 660 and 665 are identical to external target systems 480 and 490 of FIG. 4, respectively.

As previously described, most of the modifications described in conjunction with FIG. 6 require modification of the appropriate services (or the system components that produce the services). The services/components are then redeployed to the environment of the supply chain financial orchestration system. Thus, these modifications can be time consuming, and can require a careful analysis and testing procedure, as many system components of the supply chain financial orchestration system can be modified.

In accordance with certain embodiments of the invention, a supply chain financial orchestration system is provided that includes the following features: (1) usage of a universal format in communication between a task layer service and an EIL; (2) usage of a universal format in communication between the EIL and a connector service; and (3) usage of a setup-based transformation that leverages an extensible stylesheet language transformation (“XSLT”) in a connector service for transforming data from the universal format to an external target system format. As is described below in greater detail, the supply chain financial orchestration can utilize the universal format to minimize changes in an EIL and connector service of a supply chain financial orchestration system, and to protect the EIL of a supply chain financial orchestration system from such changes.

According to certain embodiments, a universal format is a data format that does not contain any restriction or constraints on the data content, and thus, is compatible with any task payload format, as well as any external target system format. Thus, task payload data of any task payload format can be transformed from the task payload format to the universal format. Further, data that is stored using the universal format can be transformed from the universal format to any external target system format.

An example of a universal format is an “anyType” data type. An anyType data type is one of the data types used in an extensible markup language (“XML”), and is the root of all XML schema types. An anyType data type can contain any XML type data, such as primitive data types, complex data types, or user-defined data types. An anyType data type has no restrictions or constraints on the data content. Another example of a universal format is a “java.lang.Object” data type in a JAVA® programming language.

According to an embodiment, a task layer service can generate task payload data using a task payload format, and transform the task payload data from the task payload format to the anyType data type. The task layer service can subsequently send the transformed task payload data to an EIL. The task layer service can further send one or more parameters used to identify an external target system. By using an anyType data type as an input data type for EIL, the EIL can be protected from any modifications to a task payload format of a task layer service. No matter what the modification to the task payload format, the task layer service can transform the task payload data to the anyType data type, and send the task payload data to the EIL, without requiring any changes to the EIL. Further, an addition of a new task layer service can also be accomplished without requiring any changes to the EIL, because the new task layer service can also transform task payload data to the anyType data type, and send the task payload data to the EIL.

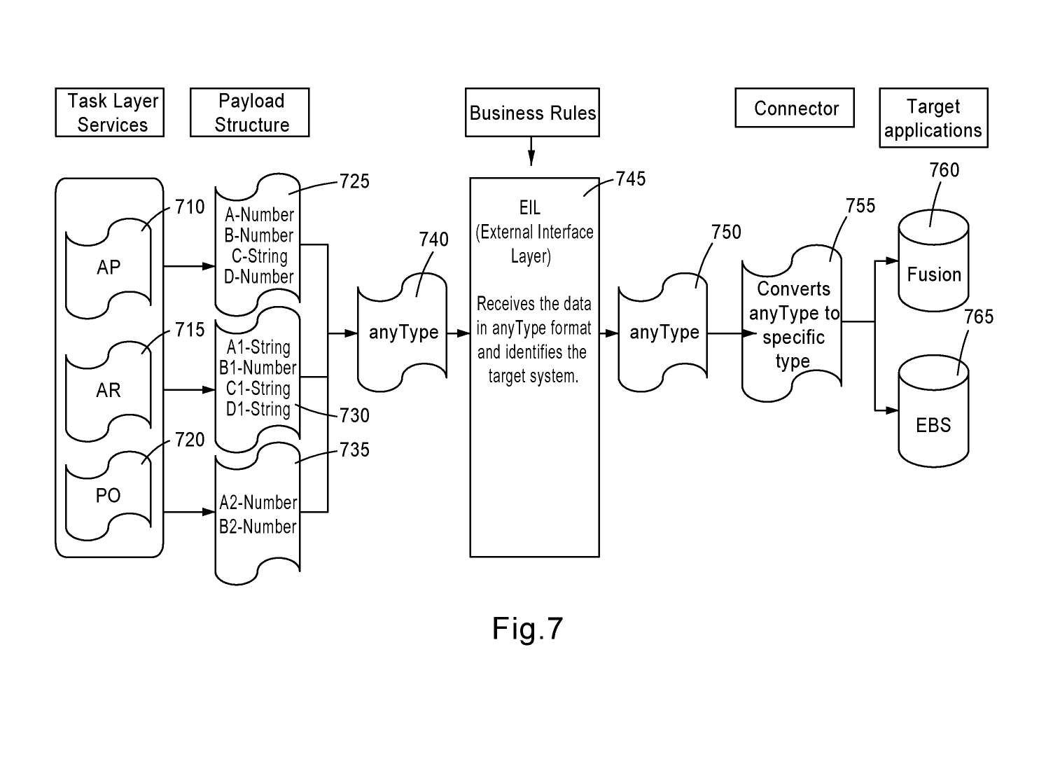

FIG. 7 illustrates a block diagram of a task communication pattern that includes a universal format, according to an embodiment of the invention. More specifically, the block diagram illustrated in FIG. 7 includes AP task layer service 710, AR task layer service 715, and PO task layer service 720. The block diagram illustrated in FIG. 7 also includes AP task payload format 725 (which is a task payload format, or “structure,” of AP task layer service 710), AR task payload format 730 (which is a task payload format of AR task layer service 715), and PO task payload format 735 (which is a task payload format of PO task layer service 715).

According to the embodiment, similar to the scenario illustrated in FIG. 6, a new parameter ‘D’ of type “String” is introduced to an AP task layer service, and a new PO task layer service is added. AP task layer service 710 is different from AP task layer service 410 of FIG. 4, as AP task layer service 710 is modified to populate a new parameter ‘D’ of type “String.” Further, AP task payload format 725 is different from AP task payload format 430 of FIG. 4, as AP task payload format 725 is modified to include the new parameter ‘D’ of type “String.” AR task layer service 715 and AR task payload format 730 are identical to AR task layer service 420 and AR task payload format 440 of FIG. 4, respectively, as no parameters of AR task layer service 715 are modified. PO task layer service 720 is a new task layer service that is not present in the block diagram illustrated in FIG. 4. Similarly, PO task payload format 735 is a new task payload format that is not present in the block diagram illustrated in FIG. 4. However, as is described below in greater detail, different from the scenario illustrated in FIG. 6, no other components require modification even in light of the new parameter introduced to the AP task service and the new PO task service.

The block diagram in FIG. 7 further includes EIL 745. According to the embodiment, AP task layer service 710 transforms its payload data from task payload format 725 to an anyType data type 740, where anyType data type 740 is an example of a universal format. Similarly, AR task layer service 715 transforms its payload data from task payload format 730 to anyType data type 740, and PO task layer service 720 transforms its payload data from task payload format 735 to anyType data type 740. Subsequently, AP task layer service 710, AR task layer service 715, and PO task layer service 720 each send their respective payload data to EIL 745 using anyType data type 740. Because EIL 745 receives anyType data type 740 as its input payload, EIL 745 is identical to EIL 450 of FIG. 4, despite the modifications to AP task payload format 725, and the inclusion of a new task payload format (i.e., PO task payload format 735). This is due to the fact that EIL 745 receives anyType data type 740 no matter the modifications to any of the task payload formats (e.g., to AP task payload format 725, AR task payload format 730, or PO task payload format 735).

According to the embodiment, in addition to anyType data type 740, AP task layer service 710, AR task layer service 715, and PO task layer service 720 can each send one or more system parameters that identify an external target system. An example setup table that includes system parameters for an AP task type, an AR task type, and a PO task type is shown below:

| Task Type | System Parameter | Target URL | Target System |
|---|---|---|---|
| AP | S1 | http://Fusion/AP | Fusion |
| AR | S2 | http://Ebs/AR | Ebs |
| PO | S3 | http://Ebs/PO | Ebs |

Thus, according to the embodiment, for the task payload data of AP task layer service 710, EIL 745 uses the system parameter “S1” that is sent by AP task layer service 710 to determine an external target system and a target URL. Once the external target system is identified, EIL 745 sends the task payload data of AP task layer service 710 to connector service 755 using anyType data type 750. Likewise, for the task payload data of AP task layer service 715, EIL 745 uses the system parameter “S2” that is sent by AP task layer service 715 to determine an external target system and a target URL. Once the external target system is identified, EIL 745 sends the task payload data of AP task layer service 715 to connector service 755 using anyType data type 750. Similarly, for the task payload data of AP task layer service 720, EIL 745 uses the system parameter “S3” that is sent by AP task layer service 720 to determine an external target system and a target URL. Once the external target system is identified, EIL 745 sends the task payload data of AP task layer service 720 to connector service 755 using anyType data type 750.

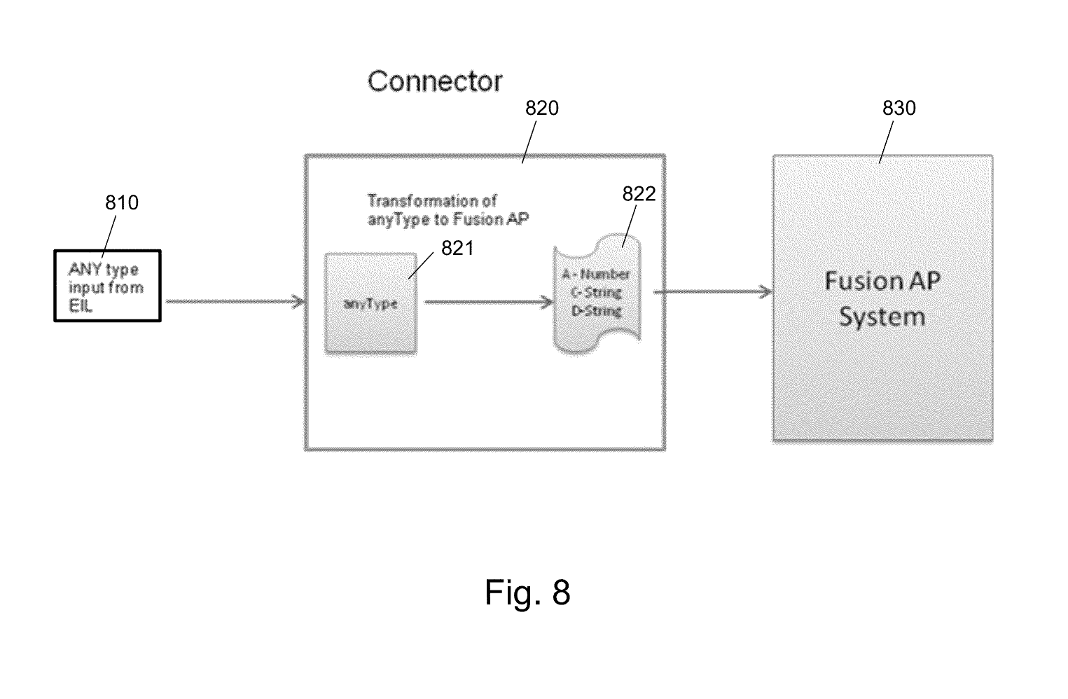

For each task payload data, connector service 755 transforms the task payload data from the anyType data type to an external target system format that corresponds to the identified external target system. The transformation is further described in greater detail in conjunction with FIG. 8. Subsequently, for each task payload data connector service 755 sends the task payload data to the identified external target system (e.g., external target systems 760 or 765) using the external target system format.

FIG. 8 illustrates a block diagram of a connector service that transforms a universal format to an external target system format, according to an embodiment of the invention. According to the embodiment, the block diagram illustrated in FIG. 8 includes connector service 820 which receives EIL input data 810 from an EIL, where the format of EIL input data 810 is an anyType data type, which is an example of a universal format. EIL input data 810 is stored within connector service 820 using anyType data type 821. Connector service 820 transforms EIL input data 810 from anyType data type 821 to an external target system format 822. Connector service 820 then sends EIL input data 810 to external target system 830 using external target system format 822.

To perform this transformation, connector service 820 can retrieve an XSLT file from a setup table stored within connector service 820 (not illustrated in FIG. 8), where the XSLT file is used to transform EIL input data 810 from anyType data type 821 to an external target system format 822. As appreciated by of ordinary skill in the relevant art, XSL is a language for transforming XML documents from a first XML format to a second XML format. With XSLT, one can: (1) add or remove elements of an XML document; (2) rearrange or sort elements of an XML document; and (3) evaluate conditions and perform actions based on content of the elements.

An example setup table that can be stored within connector service 820 is shown below:

| Task Type | Target System | XSL Transformation |
|---|---|---|
| AP | Fusion | C:\APtoFusionAP.xsl |
| AR | EBS | C:\ARToEBSAR.xsl |
| PO | EBS | C:\POToEBSPO.xsl |

As shown in the example setup table, connector service 820 can read a corresponding XSLT file stored within the setup table based on a task type and external target system, and can transform EIL input data from anyType data type 821 to external target system format 822.

In the embodiment illustrated in FIG. 8, parameter ‘B’ is dropped while transforming EIL input data 810 from anyType data type 821 to external target system format 822. This can be because external target system 830 is not interested in the parameter ‘B,’ and thus, the parameter ‘B’ is not included within external target system format 822. This is just one example modification, and the transformation from an anyType data type to an external target system format can include many different types of modifications to the input data.

Thus, according to an embodiment, the aforementioned modifications to one or more task layer services (e.g., an addition of parameters, or an addition of new task types) can only require modifications to the task layer services to create the modified business logic (e.g., logic to populate new parameters, or logic to build the new task layer services). The aforementioned modifications can optionally require modifications to the setup tables stored within an EIL and a connector service (e.g., to store the new URLs, or to store the new XSLT files). Other than the modifications to the task layer services, such modifications constitute setup data modifications, which generally do not require any system component or service to be modified or redeployed. Thus, the aforementioned modifications to one or more task layer services (e.g., an addition of parameters, or an addition of new task types) can be made more simply and more quickly.

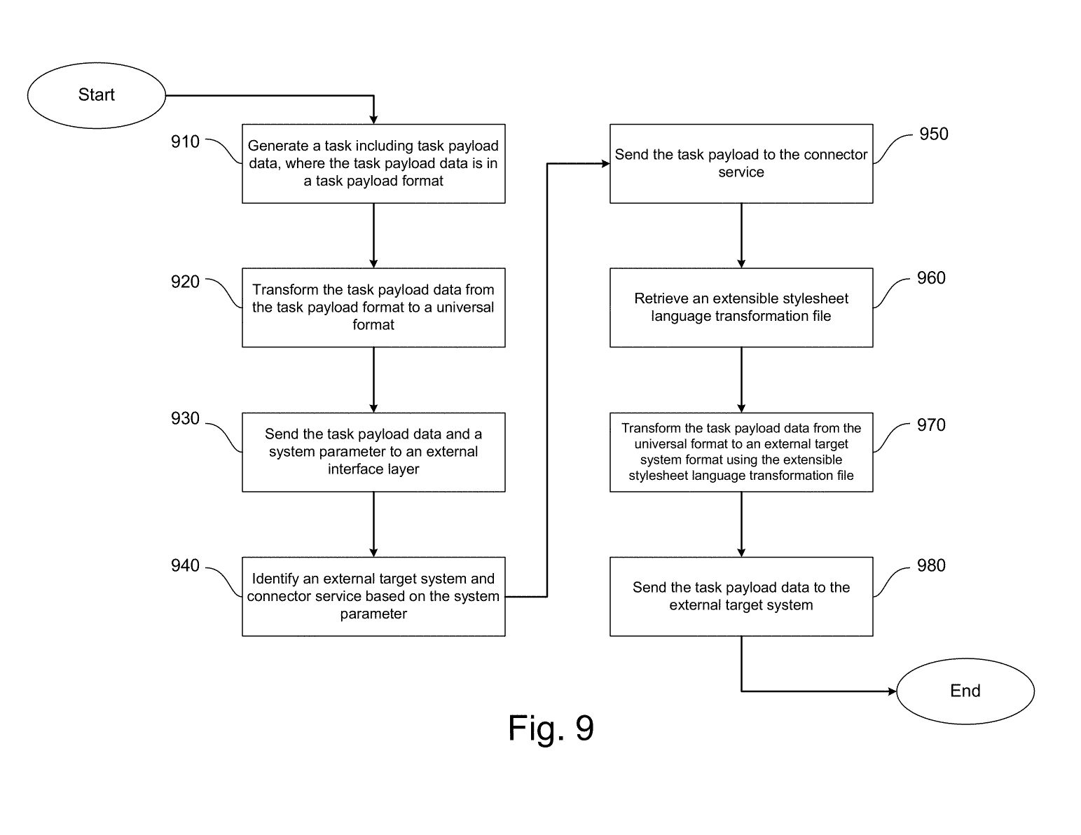

FIG. 9 illustrates a flow diagram of the functionality of a supply chain financial orchestration task communication module (such as supply chain financial orchestration task communication module 16 of FIG. 1), according to an embodiment of the invention. In one embodiment, the functionality of the flow diagram of FIG. 9 is implemented by software stored in memory or other computer-readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The flow begins and proceeds to 910. At 910, a task is generated that includes task payload data, where the task payload data is in a task payload data format. The task can be defined for a supply chain financial orchestration flow, where the supply chain financial orchestration flow defines a trade relationship between a first entity and a second entity. The generation of the task can be performed at a task layer service. The flow then proceeds to 920.

At 920, the task payload data is transformed from the task payload format to a universal format. The universal format can be an anyType data type. The anyType data type can be compatible with any task payload format and any external target system format. The transformation of the task payload data from the task payload format to the universal format can be performed at the task layer service. The flow then proceeds to 930.

At 930, the task payload data and a system parameter are sent to an EIL. The task payload data can be sent in the universal format. Further, the system parameter can identify an external target system. The system parameter can be retrieved from a setup table based on a task type of the task. The sending of the task payload data and the system parameter can be performed at the task layer service. The flow then proceeds to 940.

At 940, a target execution system and connector service can be identified based on the system parameter. The identification of the target execution system and the connector service can be performed at an EIL. The flow then proceeds to 950.

At 950, the task payload data is sent to the connector service. The task payload data can be sent in the universal format. The sending of the task payload data can be performed at the EIL. The flow then proceeds to 960.

At 960, an XSLT file is retrieved. The XSLT file can be retrieved from a setup table based on a task type of the task and the external target system. The retrieval of the XSLT file can be performed at a connector service. The flow then proceeds to 970.

At 970, the task payload data is transformed from the universal format to an external target system format using the XSLT file. The transformation of the task payload data can be performed at the connector service. The flow then proceeds to 980.

At 980, the task payload data is sent to the external target system. The task payload data can be sent in the external target system format. The external target system can execute the task based on the task payload data that is in the external target system format. Further, in certain embodiments, the task payload format of the task can be modified where the universal format is not modified. The flow then ends.

Thus, in one embodiment, a supply chain financial orchestration system can utilize a universal format to facilitate communication of task data to external target systems. Thus, any modifications to a task payload format do not necessarily affect the supply chain financial orchestration system, as the supply chain financial orchestration system is not required to modify its universal format. Further, the supply chain financial orchestration system can utilize XSLT files to facilitate transformation of task data from the universal format to an external target system format. The creation and editing of the XSLT files can be a simple task that can be performed by a text editor. Thus, a user does not need to possess technical expertise to customize the transformations, and the actual transformation can be taken care of at run time. This can reduce the effort necessary to modify and customize the communication of task data to the external target systems.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to communicate tasks, the communicating tasks comprising:
generating a supply chain task defined for a supply chain financial orchestration flow that defines a trade relationship between a first entity and a second entity, wherein the supply chain task comprises task payload data, and wherein the task payload data is in a task payload format;
transforming the task payload data from the task payload format to a universal format;
sending the task payload data and a system parameter to an external interface layer, wherein the task payload data is sent in the universal format, and wherein the system parameter identifies an external target system;
identifying an external target system and connector service based on the system parameter; and
sending the task payload data to the connector service, wherein the task payload data is sent in the universal format.

2. The computer-readable medium of claim 1, the communicating tasks further comprising:
sending, at the connector service, the task payload data to the external target system.

3. The computer-readable medium of claim 2, wherein the sending the task payload data to the external target system further comprises:
retrieving, at the connector service, an extensible stylesheet language transformation file;
transforming, at the connector service, the task payload data from the universal format to an external target system format using the extensible stylesheet language transformation file; and
sending, at the connector service, the task payload data to the external target system, wherein the task payload data is sent in the external target system format.

4. The computer-readable medium of claim 3, wherein the external target system executes the task based on the task payload data that is in the external target system format.

5. The computer-readable medium of claim 3, wherein the extensible stylesheet language transformation file is retrieved from a setup table based on a task type of the task and the external target system.

6. The computer-readable medium of claim 1, wherein the universal format comprises an extensible markup language anyType data type.

7. The computer-readable medium of claim 6, wherein the anyType data type is compatible with any task payload format and any external target system format.

8. The computer-readable medium of claim 1, the initiating further comprising modifying the task payload format of the task;
wherein the universal format is not modified.

9. The computer-readable medium of claim 1, wherein the system parameter is retrieved from a setup table based on a task type of the supply chain task.

10. The computer-readable medium of claim 1, wherein the supply chain task comprises a purchase order task.

11. A computer-implemented method for initiating an execution of a task, the computer-implemented method comprising:
generating a supply chain task defined for a supply chain financial orchestration flow that defines a trade relationship between a first entity and a second entity, wherein the supply chain task comprises task payload data, and wherein the task payload data is in a task payload format;
transforming the task payload data from the task payload format to a universal format;
sending the task payload data and a system parameter to an external interface layer, wherein the task payload data is sent in the universal format, and wherein the system parameter identifies an external target system;
identifying an external target system and connector service based on the system parameter; and
sending the task payload data to the connector service, wherein the task payload data is sent in the universal format.

12. The computer-implemented method of claim 11, further comprising:
sending, at the connector service, the task payload data to the external target system.

13. The computer-implemented method of claim 12, wherein the sending the task payload data to the external target system further comprises:
retrieving, at the connector service, an extensible stylesheet language transformation file;
transforming, at the connector service, the task payload data from the universal format to an external target system format using the extensible stylesheet language transformation file; and
sending, at the connector service, the task payload data to the external target system, wherein the task payload data is sent in the external target system format.

14. The computer-implemented method of claim 13, wherein the external target system executes the task based on the task payload data that is in the external target system format.

15. The computer-implemented method of claim 11, wherein the universal format comprises an extensible markup language anyType data type.

16. A system, comprising:
a task generation module configured to generate a supply chain task defined for a supply chain financial orchestration flow that defines a trade relationship between a first entity and a second entity, wherein the supply chain task comprises task payload data, and wherein the task payload data is in a task payload format;
a universal format transformation module configured to transform the task payload data from the task payload format to a universal format;
an external interface layer communication module configured to send the task payload data and a system parameter to an external interface layer, wherein the task payload data is sent in the universal format, and wherein the system parameter identifies an external target system;
an identification module configured to identify an external target system and connector service based on the system parameter; and
a connector service communication module configured to send the task payload data to the connector service, wherein the task payload data is sent in the universal format

17. The system of claim 16, further comprising:
an external target system communication module configured to send the task payload data to the external target system.

18. The system of claim 17, further comprising:
an extensible stylesheet language transformation file retrieval module configured to retrieve an extensible stylesheet language transformation file; and
an external target system format transformation module configured to transform the task payload data from the universal format to an external target system format using the extensible stylesheet language transformation file;
wherein the external target system communication module is further configured to send the task payload data to the external target system in the external target system format.

19. The system of claim 18, wherein the external target system executes the task based on the task payload data that is in the external target system format.

20. The system of claim 16, wherein the universal format comprises an extensible markup language anyType data type.
